(19) United States
(12) Patent Application Publication
(10) Pub. No.: US 2011/0074590 A1
(43) Pub. Date: Mar. 31, 2011

(54) SMOKE DETECTOR WITH WIRELESS MUTING SYSTEM

(76) Inventors: Eric Sacknoff, Rockville Centre, NY (US); Theodora Sacknoff, Rockville Centre, NY (US)

(21) Appl. No.: 12/719,105

(22) Filed: Mar. 8, 2010

Related U.S. Application Data
(60) Provisional application No. 61/246,515, filed on Sep. 28, 2009.

(51) Int. Cl. G08B 17/10; G06K 7/01; G08B 21/00

(52) U.S. Cl. 340/628; 340/10.5; 340/636.1

(57) ABSTRACT

A smoke detector system comprising of a localized, radio frequency, wireless Remote Control incorporated within a small magnet, such as those produced for use in kitchens, and a portable, particulate matter and/or heat sensing, smoke detector. Smoke detector is designed to emit an audible and/or lighted alarm upon activation. System is designed whereby the localized remote control is capable of muting the smoke detector alarm for a pre-set period of time.

### FIELD OF THE INVENTION

The present invention generally relates to the field of electronic safety systems for buildings and more particularly relates to the field of smoke detectors. The present invention specifically relates to a smoke detector system with wireless RFID (radio frequency identification device) timed muting facility which mutes the detector's audible alarm for a pre-programmed period of time and addresses Annoyance Alarms in a safe manner.

### BACKGROUND OF THE INVENTION

Currently, there are various smoke detectors available in the market. Smoke detectors are devices that are mounted on the wall or ceiling and automatically sound a warning when they sense smoke or other products of combustion. When people are warned early enough about a fire, they can escape before it spreads.

A smoke detector, also known as smoke alarm, is safety equipment that detects smoke and/or heat and issues an alarm to alert nearby occupants that there is a potential fire condition. Smoke alarms automatically detect the presence of smoke and/or heat and are recognized life savers.

The first battery-operated home smoke detector was invented in 1969 by Randolph Smith and Kenneth House. In 1902 George Andrew Darby, an electrical engineer of 211 Bloomsbury Street, Birmingham, England, claimed the electrical Heat-Indicator and Fire Alarm. The device indicated any change of temperature in the apartment where it was fixed. The device operated by closing an electrical circuit to sound an alarm if the temperature rose above the safe limit. The contact was made by bridging a gap with a conductor or allowing one plate to fall upon another: this movement was caused simply by a block of butter which melted as the temperature rose.

Photo-electric detectors contain a light source (usually a bulb) and a photocell, which is activated by light. Photoelectric smoke detectors utilize a light-sensitive cell in either of two ways. In one type, a light source, e.g., a small spotlight causes a photoelectric cell to generate current that keeps an alarm circuit open—until visible particles of smoke interrupt the ray of light, thus breaking the circuit and setting off the alarm.

The other type of photoelectric detector, widely used in private dwellings, employs a detection chamber shaped so that the light-sensitive element cannot ordinarily “see” the light source (usually a light-emitting diode [LED]). When particles of smoke enter a portion of the chamber that is aligned with both the LED and the photocell, the particles diffuse or scatter the light ray so that it may be detected by the photocell. As a result, a current is generated by the light-sensitive cell and the alarm is triggered.

Ionization detectors contain radioactive material which ionizes the air, making an electrical path. When smoke enters, the smoke molecules attach themselves to the ions. The change in electric current flow triggers the alarm. The radioactive material is called Americium. It's a radioactive metallic element produced by bombardment of plutonium with high energy neutrons. Americium 241 (Am-241), a radioactive isotope, has been the preferred source material for Ionization Smoke Detectors since the late 1970s. It is usually processed with gold and sealed within gold and silver foils. The amount is very small and not harmful.

Battery-powered smoke detectors are stand-alone units. Most residential smoke detectors run on alkaline batteries. If these batteries run out of power, the smoke detector will become inactive. Most smoke detectors are designed to signal a low battery condition, but it is common for houses to have smoke detectors with dead batteries.

As a result, public information campaigns have been created to remind people to change their smoke detector batteries regularly. In regions using daylight saving time, these campaigns usually suggest that people change their batteries when they change their clocks. Some detectors are also being sold with a lithium battery that can run for about 7 to 10 years, though this might actually make it less likely for people to change batteries since their replacement is needed so infrequently. Most detectors today, particularly those installed during new construction, are hard-wired to the main electrical system of the structure. Many of these units also include a battery backup to ensure operation during a power outage.

Annoyance alarms may be defined as a smoke detector activation due to a non-emergency smoke or dust condition. This type of alarm occurs most frequently in the kitchen and is mostly due to cooking smoke that is not fire or emergency related. A dangerous consequence of kitchen annoyance alarms is battery removal. In many cases of both intended and unintended smoky cooking, an occupant will be subjected to continued alarming of the smoke detector. In order to cancel the alarming, many occupants remove the battery from the smoke detector. Since smoke detectors are placed high on a wall or on a ceiling, battery removal will usually require the use of a chair or ladder. A common consequence is that the removed battery is never replaced, the smoke detector becomes inactive, and a dangerous, potentially life threatening situation is created.

The prior art existent in the field is as follows:

US Patent No: US 20030179096 details a wireless fire detection and door bell system that includes a smoke detector having a first transmitter; a door bell button having a second transmitter and a chime providing two different audio signals in response to the first and second transmitters respectively.

US Patent No: U.S. Pat. No. 6,084,522 claims a wireless integrated smoke detector and temperature monitoring device. The device comprises a photoelectric sensor for determining the presence of smoke, a thermo-resistor for providing a temperature signal reflective of the temperature level, a processing means for monitoring the smoke and temperature, and a transmission means for transmitting messages to the alarm system controller. Rather than transmitting the actual temperature to the system controller, the transmitter transmits a status message which comprises status signals for low temperature trouble conditions, smoke or heat alarm, and also low temperature trouble conditions with smoke or heat alarm. To conserve battery power, the device alternates between a sleep mode and a wake mode. During the wake mode the trouble conditions are checked by the processor and if necessary, a status message is transmitted.

US Patent No: US20090109016 provides a smoke detector system which employs smoke detectors that enter a “lockout period” following receipt of an alarm signal, during which time a detector will not receive a RF alarm signal and will not transmit a RF alarm signal after a certain period of time if that detector does not detect, or no longer detects, a dangerous condition. The lockout period is of sufficient duration to prevent re-transmission of a RF alarm signal by a detector even though it may have received a RF alarm signal from another detector(s). Hence, after a short period of time, no RF alarm signals will be received or transmitted and each detector resets, unless a dangerous condition is detected.

US Patent No: US2006226972 describes a wireless emergency alarm notification system for detecting a signal produced by a pre-existing smoke detector in a structure and for notifying persons in the immediate vicinity of a structure and in the surrounding area, as well as emergency personnel, of an emergency situation.

US Patent No: U.S. Pat. No. 4,363,031 describes a wireless smoke alarm system in which each detector includes a local smoke detector and an alarm. These are coupled to a transmitter and a receiver. The transmitter and receiver are within range of similar units so that an alarm sounded by one unit causes those within range to sound their respective alarms. In sounding their respective alarms, the local units also cause their transmitters to transmit alarm signals thereby overlapping and reinforcing the first unit. A master controller is interfaced with the alarm detection and local alarming components and the transceiver to disconnect the unit when the alarm is ended and to transmit a signal to other units, causing each to discontinue their respective alarms.

US Patent No: U.S. Pat. No. 6,420,973 discloses a wireless smoke detection system that includes a plurality of detector units strategically positioned throughout the monitored area. Each of the plurality of detector units includes a detector for sensing individual characteristic conditions within a section of the monitored area and generating a signal indicative of the monitored. A signal processor is connected within each detector unit for analyzing the signal generated by the detector and upon determining if the signal is above a predetermined level an emergency signal is generated. A transmitter is provided for transmitting the emergency signal to a plurality of receiver units strategically positioned about the monitoring area. Each receiver unit includes an alarm for generating an alarm signal and thereby alerting persons within the monitored area to the emergency situation. The detector may be at least one of a photoelectric smoke detector, an ionization type detector, a combination carbon monoxide and smoke detector, a carbon monoxide detector, a near infrared detector or a hazard detector.

US Patent Publication No: 20090174562 claims a smoke detector battery capacity test that can be performed via an infrared (IR) trigger from a remote controller. When the proper amount of directed infrared energy (sourced by an infrared remote control device) is detected at the smoke detector the smoke detector runs the battery life test. The result of the battery test is displayed on a visual indicator on the smoke detector unit.

However, the purpose and methodology of all the inventions that are part of prior art do not envisage the unique embodiment of a portable smoke detector with a wireless, remote controlled RFID mute facility that is easy to use, easily accessible and helps in muting Annoyance Alarms.

Thus, there arises a need to provide a method which offers a smoke detector with an easy to operate, remote muting system which mutes the alarm for a pre-programmed, short period of time and negates an occupant's desire to remove batteries so as to end Annoyance Alarms. The present invention overcomes these and other problems by providing a smoke detector interfaced with a remote controlled RFID muting device. The smoke detector body will look and function as normal. However, the detector shall have installed an electronic receiver/processor interfaced with the audible alarming facility of the detector. The electronic receiver/processor shall be designed so as to be activated via a localized RFID signal from a remote transponder.

Upon receipt of the RFID signal, the receiver/processor will shut-off the audible alarming capability of the detector for a pre-programmed, set period of time, say one minute, and thus mute the audible alarm. Upon passing of the pre-programmed time period, the smoke detector's audible alarm function will become operational. If the Annoyance smoke condition still exists, then the occupant may use the remote control to once again engage the smoke detector's electronic receiver/processor and mute the detector's audible alarm. This capability negates the occupant's action of battery removal and maintains the portable smoke detector operational. The remote control's audible alarm muting function only affects the circuitry within the body of the smoke detector which electronically activates the audible alarm. The smoke detector's sensing facilities remain intact and running.

Further, it will be apparent to those skilled in the art that the objects of this invention have been achieved by providing a smoke detector with an easy to operate remote controlled RFID muting system, which is unique in nature unlike existing smoke detector shut-off systems that are suited only for limited purposes. Various changes may be made in and without departing from the concept of this invention. Further, features of some stages disclosed in this application may be employed with features of other stages.

Therefore, the scope of the invention is to be determined by the terminology of the following description and the legal equivalents thereof.

### SUMMARY OF THE INVENTION

This present invention may be summarized, at least in part, with reference to its objects.

The foremost object of this invention is to provide a smoke detector with a wireless RFID muting system.

Another objective of this invention is to provide a smoke detector with a wireless RFID muting system that is activated by a portable, battery operated, transponder.

Another objective of this invention is to provide a smoke detector with a wireless RFID muting mechanism that has a timed feature for the wireless muting operation.

Another objective of this invention is to provide a smoke detector with a wireless RFID muting system which is compact and easily accessible in a living place.

Another objective of this invention is to provide a smoke detector with a wireless RFID muting mechanism which is repeatedly usable without any operating delay after a particular use.

A further objective of this invention is to provide a smoke detector with a wireless RFID muting system in which the batteries need not be removed to stop the audible alarming.

Additional objects and embodiments of the invention will be set forth in part in the description which follows, and in part will become apparent to those skilled in the art upon examination of the following, or may be learned by practice of the invention. These and other objects and advantages and features of the present invention will be more readily apparent when considered in reference to the following description, and in part will become apparent to those skilled in the art upon examination of the following, or may be learned by practice of the invention.

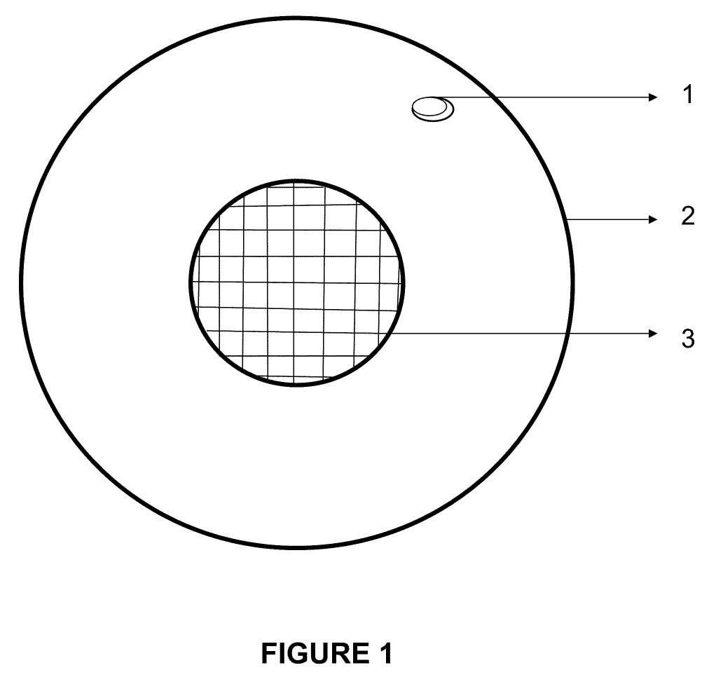

FIG. 1 is a cross sectional diagram of the smoke detector body with the integrated RDIF receiver/processor.

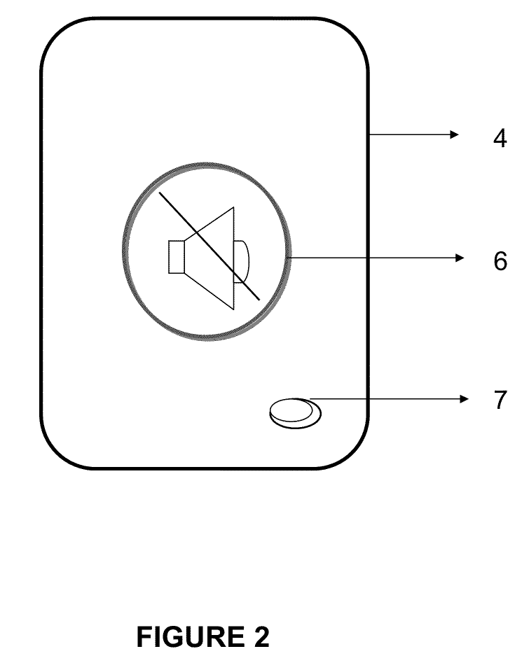

FIG. 2 is a schematic diagram of the front view of the body of the RFID transponder.

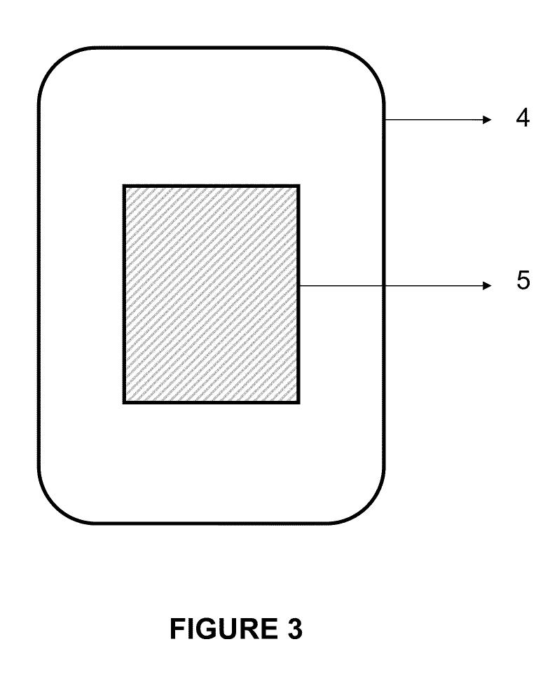

FIG. 3 is a schematic diagram of the rear view of the body of the RFID transponder.

### DETAILED DESCRIPTION OF THE INVENTION

The following description is presented to enable any person skilled in the art to make and use the invention, and is provided in the context of particular applications of the invention and their requirements. The present invention can be configured as follows:

The present invention comprises of an alarming system electronically interfaced with an RFID mechanism for sensor shut-off. FIG. 1 depicts the smoke detector body with the integrated RDIF receiver/processor (2), a test button/alarm light (1) and a speaker (3). FIG. 2 shows the mute button (6) in the front view of the body of the RFID transponder (4) and a low battery indicator (7). FIG. 3 illustrates the rear view of the body of the RFID transponder (4) containing the magnet (5).

In one embodiment of this invention, the RFID signals may be transmitted by a battery operated RFID transponder (4) incorporated within an easily accessible device in the kitchen such as a kitchen magnet. The RFID transponder (4) integrated into the magnet device (5) for use in the kitchen is coupled with the said RFID receiver/processor facility of the smoke detector (2), and may be configured to remain in ready-state, until activated via physical interaction with a button or switch (6).

In a second embodiment of this invention, the RFID transponder (4) may be configured so as to be capable of transmitting the RFID ‘mute’ signal to the smoke detector (2) through use of the mute button (6), without requiring an activation signal from the smoke detector (2).

If smoke is produced in the room and rises up to the smoke detector (2), it then penetrates the smoke inlet opening or openings on the cover lid and triggers the detector circuit thus activating an audible alarm (3). Once the audible alarm (3) is activated, accessing the de-activation mechanism (button, switch or lever) (6) on the remote control will mute the audible alarm (3). Utilization of the de-activation mechanism (6) on the remote control will not affect the smoke/heat sensing mechanism on the smoke detector (2), only the circuitry powering/signaling the audible alarm (3) is affected.

The RFID signals may conform to RFID protocols known in the art, or to any other wireless communication protocols including but not limited to Global System for Mobile Communications (GSM), Bluetooth, infrared etc.

The present invention thus provides occupants a means to easily mute a smoke detector (2) Annoyance Alarm (3) for a pre-programmed period of time through providing for a smoke detector (2) interfaced with a portable RFID transponding unit (4) incorporated within a Kitchen-type magnet (5).

The intent of the present invention is to help maintain kitchen smoke detectors in the maximally possible ready mode. This negates the problems associated with removing the batteries in a smoke detector for an Annoyance Alarm situation and forgetting to replace said batteries, thusly defeating the purpose of having the smoke detector in the first place.

For example, if a house resident is cooking ‘blackened fish’, the normal smoke from this dish may set off the kitchen smoke detector. The present invention enables a house resident to mute the alarm for a specified, pre-programmed time period by pressing the remote transponder's (4) RFID mute button (6). After the specified pre-programmed time period passes, the smoke detector's (2) audible alarm (3) will once again be active. The house resident can repeat this sequence any number of times and does not need to remove the battery in order to mute the alarm.

The current invention is thus able to provide a wirelessly activated mute mode for a smoke detector (2) through use of an RFID transponder (4) incorporated into a kitchen-type magnet (5) while maintaining the advantages of small size, compactness, and low-price. The incorporation of said transponder (4) into a kitchen-type magnet device (5) provides for easy access and maintains transponder/receiver proximity through the dual function of the magnet (5) as a normally used kitchen magnet and as the holder for the RFID transponder (4).

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

It will be apparent to those skilled in the art that the objects of this invention have been achieved by providing the above invention. However various changes may be made in the structure of the invention without departing from the concept of the invention. Therefore, the scope of the invention is to be determined by the terminology of the following claims and the legal equivalents thereof.

What is claimed is:

1. A portable smoke detector RFID muting system comprising of a portable battery operated smoke detector (2) and a portable, battery operated transponder (4) characterized in that the muting function is accomplished by said devices via an RFID signaling transmitter incorporated into a magnet (5) device such as a common kitchen-type magnet.

2. A portable smoke detector RFID muting system as claimed in claim 1 wherein said smoke detector circuitry (2) is provided with an RFID receiver/processor module incorporated within the printed circuit board of said portable smoke detector (2).

3. A portable smoke detector RFID muting system as claimed in claim 2 wherein said smoke detector RFID receiver/processor module is configured so as to activate upon receipt of an RFID signal of a particular frequency.

4. A portable smoke detector RFID muting system as claimed in claim 1 wherein smoke produced rises up to said smoke detector (2), penetrates smoke inlet opening or openings and triggers said detector circuitry thus activating an audible alarm.

5. A portable smoke detector RFID muting system as claimed in claim 3 wherein said RFID receiver/processor module incorporated within the circuit board of said smoke detector (2) is electronically interfaced with the audible alarming facility (3) of said smoke detector (2).

6. A portable smoke detector RFID muting system as claimed in claim 5 wherein said RFID receiver/processor module incorporated within the circuit board of said smoke detector (2) is electronically interfaced with the audible alarming facility (3) of said smoke detector (2) so as to be capable of electronically controlling said audible alarming function.

7. A portable smoke detector RFID muting system as claimed in claim 6 wherein said RFID receiver/processor module incorporated within the circuit board of said smoke detector (2) is designed such that activation is programmed to suspend the audible alarming circuitry of said portable smoke detector (2).

8. A portable smoke detector RFID muting system as claimed in claim 7 wherein said RFID receiver/processor module's audible alarm suspension feature (2), (3) is programmed to mute the audible alarm or a set period of time.

9. A portable smoke detector RFID muting system as claimed in claim 1 wherein said kitchen-type magnet (5) contains a battery operated RFID transponder (4) for RFID signal transmission.

10. A portable smoke detector RFID muting system as claimed in claim 1 wherein said kitchen-type magnet transponder (4) transmits an RFID signal on the same frequency as that set on the receiver/processor module located within the body of the smoke detector (2).

11. A portable smoke detector RFID muting system as claimed in claim 10 wherein said kitchen-type magnet transponder (4) transmits an RFID signal on the same frequency as that set on the receiver/processor module located within the body of the smoke detector (2) and that such transmission activates the receiver/processor module incorporated within the body of the smoke detector (2).

12. A portable smoke detector RFID muting system as claimed in claim 1 wherein said RFID transponder (4) in said kitchen-type magnet (5) is electronically configured to remain inactive until it is activated via physical means, i.e. pressing a ‘mute’ button (6) or activating a switch.

13. A portable smoke detector RFID muting system as claimed in claim 12 wherein said RFID transponder (4) in said kitchen-type magnet (5) is operated through pressing said mute button (6), and transmitting the RFID signal to said smoke detector receiver/processor module (2) without requiring an activation signal from said smoke detector (2).

14. A portable smoke detector RFID muting system as claimed in claim 1 wherein said RFID transponder (4) in said kitchen-type magnet (5) contains a ‘low battery’ indicator light (7).

15. A portable smoke detector RFID muting system as claimed in claim 1 wherein said RFID transponder (4) in said kitchen-type magnet (5) may receive commands and perform an action including but not limited to activating, deactivating, or resetting said RFID transponder (4) through the use of said mute button (6).
